(19) United States
(12) Patent Application Publication
(10) Pub. No.: US 2004/0241581 A1
(43) Pub. Date: Dec. 2, 2004

(54) Optical information-recording medium

(75) Inventors: Hironori Kakiuchi, Tokyo (JP); Hiroyasu Inoue, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 10/854,160

(22) Filed: May 27, 2004

(30) Foreign Application Priority Data
May 30, 2003 (JP) 2003-153574

(51) Int. Cl. G11B 7/24

(52) U.S. Cl. 430/270.12; 430/945; 428/64.8

(57) ABSTRACT

An optical information-recording medium which is capable of reducing dependency on the wavelength of a laser beam used in recording and reproducing data, while preventing occurrence of corrosion of a recording film and a crack in a dielectric film. Dielectric films of a recording layer other than a farthest information layer as viewed from the direction of irradiation of the laser beam have thicknesses thereof defined such that when the laser beam is irradiated onto the information layer, a reflectance of the information layer exhibited with respect to a laser beam in a first wavelength region ranging from 370 nm to 380 nm, and a reflectance of the same exhibited with respect to a laser beam in a second wavelength region ranging from 610 nm to 640 nm both assume minimum values relative to reflectances of other laser beams whose wavelengths are outside the first and second wavelength regions.

### BACKGROUND OF THE INVENTION

1. Field of the Invention

The present invention relates to an optical information-recording medium formed by depositing a plurality of information layers on a base.

2. Description of the Related Art

As this kind of optical information-recording medium, Japanese Laid-Open Patent Publication (Kokai) No. 2001-243655 discloses an optical information-recording medium having two information layers, i.e. a first information layer and a second information layer, formed on a first base. The optical information-recording medium is comprised of the first information layer, an separation layer, the second information layer, and a second base, sequentially deposited on the first base in the form of a disk made of a light-transmitting resin or a glass, in the mentioned order. The optical information-recording medium is configured to be capable of recording and reproducing data on and from the first and second information layers by irradiating a laser (laser beam) onto the two information layers from the side of the first base. Further, the first information layer is comprised of a lower protective layer, a recording layer, an upper protective layer, a reflecting layer, and a transmittance-increasing layer, sequentially deposited on the first base in the mentioned order. In this case, the recording layer is in the form of a thin film made of a phase change material, and the lower protective layer and the upper protective layer are each formed in the form of a thin film made of a dielectric material. Further, the second information layer is comprised of a plurality of layers substantially equivalent to the layers forming the first information layer, sequentially deposited on the separation layer.

To record data on the optical information-recording medium, the laser beam adjusted to a recording power is irradiated onto the recording layer. At this time, portions of the recording layer irradiated with the laser beam have their state (at least one of a physical state and a chemical state) changed, whereby recording marks are formed on the recording layer. These portions of the recording layer, thus formed with the recording marks, are different in optical characteristics from a blank area (unrecorded area) of the recording layer, which has no recording marks formed therein. Therefore, when a laser beam adjusted to a reproducing power is irradiated onto the portions formed with the recording marks, the optical information-recording medium exhibits a different reflectance from a reflectance which the optical information-recording medium exhibits when the laser beam is irradiated onto the blank area. Therefore, by detecting the difference between the reflectances, it becomes possible to reproduce recorded data.

In this case, to record data on the second information layer, the laser beam is applied onto the second information layer through the first information layer. Further, to reproduce the data recorded on the second information layer, the laser beam is applied onto the second information layer through the first information layer, and after having reflected from the second information layer, the laser beam passes through the first information layer again, to be emitted out through the first base. Therefore, to accurately perform the recording and reproducing of data, the first information layer is required to have a sufficient transparency. To this end, the optical information-recording medium of the above-mentioned kind is configured, for example, such that it has no reflecting film formed on an information layer (the first information layer, in the above example) on the near side as viewed from the direction of irradiation of the laser beam onto the optical information-recording medium, or such that the thicknesses of layers (mainly dielectric layers: the lower protective layer and the upper protective layer in the above example) forming the information layer are reduced, to thereby enhance transparency to the laser beam.

However, as a result of the study of the above conventional optical information-recording medium, the present inventors found the following problems: To enhance the transparency to the laser beam, the conventional optical information-recording medium is configured, for example, such that no reflecting film is formed on the first information layer, or such that the lower protective layer and the upper protective layer (hereinafter also referred to as “the dielectric films”) of the first information layer are reduced in thickness (e.g. the thicknesses of the protective layers are set to 25 nm). However, when the dielectric films are formed as thin films without providing a reflecting film, there occurs a problem that the recording layer is easily corroded with water or the like in the atmosphere. On the other hand, when the medium is configured such that a reflecting film is formed on the first information layer to thereby enhance waterproofness for preventing corrosion of the recording layer, the transmittance of the first information layer is reduced due to the presence of the reflecting film. This makes it difficult to record and reproduce data on and from the second information layer. Further, when the dielectric films are formed to have a very large thickness to increase waterproofness, there is a fear that the dielectric films are cracked when the whole optical information-recording medium is largely bent or when the optical information-recording medium experiences a sharp change in temperature. Accordingly, it is preferred that the dielectric films are formed to have a transmittance high enough to enable data to be recorded and reproduced on and from the second information layer, and a thickness increased but small enough to prevent occurrence of a crack, to thereby enhance waterproofness for prevention of corrosion of the recording layer.

On the other hand, the laser beam used for recording and reproducing data on and from the optical information-recording medium of the above-mentioned kind has some variation in wavelength due to differences between individual recording and reproducing apparatuses, and environments, such as temperature and moisture. More specifically, when data is recorded and reproduced, for example, on and from an optical information-recording medium which is designed according to standards for the use of a laser beam (blue-violet laser beam) having a wavelength of 405 nm, for example, the wavelength of the laser beam emitted from a recording and reproducing apparatus varies in a range of approximately 395 nm to 415 nm as one example. Therefore, to enable accurate recording and reproduction of data even if the wavelength of the laser beam varies within the above range, it is necessary to define the thickness of dielectric film such that the amount of change in transmittance caused by a change in the wavelength of the laser beam is very small (such that dependency on the wavelength of the laser beam is minimized). In this case, the present inventors have confirmed that there is no proportionality between the amount of change in the wavelength of the laser beam and the amount of change in the transmittance of the laser beam, but that there exists a wavelength region on a film thickness-by-film thickness basis, in which the amount of change in the transmittance of the dielectric film is minimized with respect to the amount of change in the laser wavelength. Therefore, it is required to define the thickness of each dielectric film such that the amount of change in the transmittance is minimized with respect to the wavelength (in a wavelength region between 380 nm to 450 nm, in the present case: blue-violet laser beam) of a laser beam used for recording and reproducing data on and from the optical information-recording medium.

### SUMMARY OF THE INVENTION

The present invention has been made to solve the problems described above, and a main object thereof is to provide an optical information-recording medium which is capable of reducing dependency on the wavelength of a laser beam used in recording and reproducing data, while preventing occurrence of corrosion of a recording film and a crack in a dielectric film.

To attain the above object, the present invention provides an optical information-recording medium including a plurality of information layers from a first information layer to an N-th information layer (N is a natural number not smaller than 2) sequentially formed on a base in the mentioned order, for recording and reproducing data by irradiating a laser beam onto the information layers, wherein an M-th information layer (M is a natural number not larger than N), which is one of the N information layers, other than an information layer as a farthest information layer (information layer which is most distant from an irradiation source of the laser beam during recording or reproduction) as viewed from a direction of irradiation of the laser beam onto the optical information-recording medium, is formed by depositing a first dielectric film and a second dielectric film, and a recording film formed between the first and second dielectric films such that the data can be recorded thereon, one upon another, and wherein the first and second dielectric films have thicknesses thereof defined such that when the laser beam is irradiated onto the M-th information layer, a reflectance of the M-th information layer exhibited with respect to a laser beam in a first wavelength region ranging from 370 nm to 380 nm, and a reflectance of the M-th information layer exhibited with respect to a laser beam in a second wavelength region ranging from 610 nm to 640 nm both assume minimum values relative to reflectances of other laser beams whose wavelengths are outside the first and second wavelength regions.

With the arrangement of this optical information-recording medium, the M-th information layer is formed by defining the respective thicknesses of the first and second dielectric films such that when the laser beam is irradiated onto the M-th information layer, a reflectance of the M-th information layer exhibited with respect to a laser beam in a first wavelength region ranging from 370 nm to 380 nm, and a reflectance of the M-th information layer exhibited with respect to a laser beam in a second wavelength region ranging from 610 nm to 640 nm both assume minimum values relative to reflectances of other laser beams whose wavelengths are outside the first and second wavelength regions. This makes it possible to record and reproduce data on and from the farthest information layer, in a stable manner while preventing occurrence of corrosion of the recording film and cracks in the dielectric films, and reduction of recording sensitivity of the recording film.

In this case, it is preferred that at least one of the first and second dielectric films is formed of a material containing a mixture of ZnS and SiO₂ as a main component such that a thickness thereof is within a range of 100 nm to 130 nm. It should be noted that in the present invention, the term “main component” is intended to mean a component which has the largest composition ratio (atomic ratio) of a plurality of elements forming a film or a layer. According to this preferred embodiment, the reflectances of the laser beams whose wavelengths are in the first and second wavelength regions both assume the minimum values relative to the reflectances of the other laser beams whose wavelengths are outside the first and second wavelength regions. In this case, the elements ZnS and SiO₂ have a relatively small extinction coefficient (k) with respect to the blue-violet laser beam, and hence it is possible to reliably prevent the recording sensitivity of the recording film from being reduced. Further, differently from a case where the thickness of the dielectric film is defined to be smaller than 100 nm, it is possible to reliably prevent the recording film from being corroded with water or the like in the atmosphere. Furthermore, differently from a case where the thickness of the dielectric film is defined to be larger than 130 nm, it is possible to positively prevent occurrence of a crack in the dielectric film.

Further, it is preferred that the dielectric film of the M-th information layer formed on a far side as viewed from the direction of irradiation of the laser beam (dielectric film located farthest from the irradiation source of the laser beam during recording or reproduction) is formed of a material containing a mixture of ZnS and SiO₂ as a main component, and the dielectric film of the M-th information layer formed on a near side as viewed from the direction of irradiation of the laser beam (dielectric film located nearer to the irradiation source of the laser beam) is formed of a material containing TiO₂ as a main component. In this case, it is more preferable that the dielectric film on the near side is formed such that it has a thickness within a range of 15 nm to 40 nm. According to this preferred embodiment, the reflectances of the laser beams whose wavelengths are in the first and second wavelength regions assume minimum values relative to reflectances of other laser beams whose wavelengths are outside the first and second wavelength regions. In this case, since TiO₂ has a high index of refraction (n) and a relatively small extinction coefficient (k), with respect to the blue-violet laser beam, it is possible to make conspicuous the amount of change in optical characteristics of the farthest information layer before and after recording of data on the recording film, and prevent the recording sensitivity of the recording film from being degraded.

Further, it is preferred that the recording film is formed by depositing a first auxiliary recording film, and a second auxiliary recording film formed of a material different from a material forming the first auxiliary recording film. According to this preferred embodiment, it is possible to obtain a sufficiently large difference in reflectance between before and after recording of data on the recording film, while preventing increases in manufacturing costs.

Also, it is preferred that the first and second auxiliary recording films are formed by materials containing respective ones different from each other and selected from the group consisting of Al, Si, Ge, Sn, Zn, Cu, Mg, Ti, and Bi. According to this preferred embodiment, the difference in reflectance between before and after irradiation of the laser beam adjusted to a recording power is large, and at the same time the difference in transmittance between before and after the irradiation is small, so that it is possible to reliably and easily form readable recording marks without obstructing the recording and reproduction of data on and from the farthest information layer.

Further, it is preferred that one of the first and second auxiliary recording films is formed of a material containing Cu as the main component, and the other of the first and second auxiliary recording films is formed of a material containing Si as the main component. According to this preferred embodiment, the difference in reflectance between before and after irradiation of the laser beam (blue-violet laser beam) adjusted to the recording power, having a wavelength within a range of 380 nm to 450 nm, is large, and at the same time the difference in transmittance between before and after the irradiation is small, so that when the blue-violet laser beam is used, it is possible to reliably and easily form readable recording marks without obstructing the recording and reproduction of data on and from the farthest information layer.

It should be noted that the present disclosure relates to the subject matter included in Japanese Patent Application No. 2003-153574 filed on May 30, 2003, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a cross-sectional view showing the construction of an optical information-recording medium according to an embodiment of the present invention;

FIG. 2 is a cross-sectional view mainly showing the construction of an L0 information layer of the optical information-recording medium;

FIG. 3 is a cross-sectional view mainly showing the construction of an L1 information layer of the optical information-recording medium;

FIG. 4 is a reflectance characteristics diagram showing the relationship between the thickness and the reflectance of a dielectric film, in which a solid line indicates the relationship between the thickness and the reflectance of the dielectric film obtained when a laser beam L is irradiated onto a blank area of the L1 information layer, and a broken line indicates the relationship between the thickness and the reflectance of the dielectric film obtained when the laser beam L is irradiated onto a portion of the L1 information layer, formed with a recording mark;

FIG. 5 is a transmittance characteristics diagram showing the relationship between the wavelength of the laser beam L and the transmittance of the L1 information layer, in which a solid line indicates the relationship between the wavelength of the laser beam L and the transmittance of the L1 information layer, obtained when the laser beam L is irradiated onto an L1 information layer including a dielectric film having a thickness defined to be 110 nm, and a broken line indicates the relationship between the wavelength of the laser beam L and the transmittance of the L1 information layer, obtained when the laser beam L is irradiated onto an L1 information layer including a dielectric film having a thickness defined to be 25 nm; and

FIG. 6 is a reflectance characteristics diagram showing the relationship between the wavelength of the laser beam L and the reflectance of the L1 information layer, obtained when the laser beam L is irradiated onto L1 information layer including respective dielectric films having various thicknesses.

### DESCRIPTION OF THE PREFERRED EMBODIMENTS

The present invention will now be described in detail with reference to the accompanying drawings showing a preferred embodiment thereof.

First, a description will be given of the construction of an optical information-recording medium 1 according to the present invention.

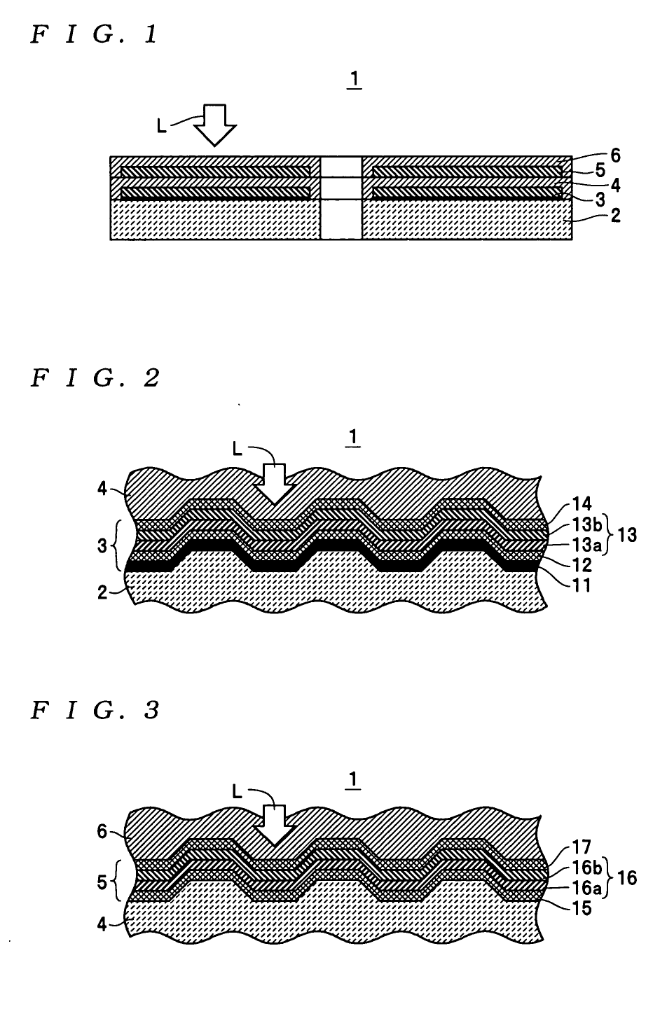

The optical information-recording medium 1 shown in FIG. 1 is an optical disk of a one-side multilayer recording type, having an outer diameter of approximately 120 mm and a thickness of approximately 1.2 mm, and configured to be capable of recording and reproducing data using a blue-violet laser beam (hereinafter referred to as “the laser beam”) L having a laser wavelength within a range of 380 nm to 450 nm (e.g. 405 nm). More specifically, the optical information-recording medium 1 is comprised of an L0 information layer 3, a transparent intermediate layer 4, an L1 information layer 5, and a light transmitting layer 6, sequentially deposited on a base 2 in the mentioned order.

The base 2 is in the form of a disk made e.g. of a polycarbonate resin by the injection molding method or the 2P method. One surface (upper surface as viewed in FIG. 1) of the base 2 is formed with grooves and lands extending helically from a central portion of the base 2 toward the outer periphery thereof. In this case, the grooves and the lands function as guide tracks for recording and reproducing data on and from the L0 information layer 3 formed on the base 2. Therefore, to enable accurate tracking to be performed, it is preferable to form grooves, for example, such that they have a depth within a range of 10 nm to 40 nm, and a pitch within a range of 0.2 μm to 0.4 μm. Further, the optical information-recording medium 1 is configured such that the laser beam L is to be irradiated from the side of the light transmitting layer 6 when data is recorded or reproduced. Therefore, the base 2 is not required to have a light transmittance, so that the optical information-recording medium 1 has more options for selecting materials for forming the base 2 than the conventional media. More specifically, the material for forming the base 2 is not limited to the above-mentioned polycarbonate resin, but resin materials, such as an olefin resin, an acrylic resin, an epoxy resin, a polystyrene resin, a polyethylene resin, a polypropylene resin, a silicone resin, a fluorocarbon resin, an ABS resin, and an urethane resin, as well as glass and ceramic materials can be employed as the base-forming material. However, it is preferable to employ the resin materials, such as the polycarbonate resin and the olefin resin, which are easy to mold and relatively inexpensive.

The L0 information layer 3, which corresponds to a first information layer in the present invention, forms an information layer on the far side (“farthest information layer” in the present invention) as viewed from the direction of irradiation of the laser beam L onto the optical information-recording medium 1. Although in this case, the L0 information layer 3 can be formed as a reproduction-only information layer, in the optical information-recording medium 1 according to the embodiment of the present invention, as shown in FIG. 2, the L0 information layer 3 is formed by a write-once information layer having a reflecting film 11, a dielectric film 12, a recording film 13, and a dielectric film 14, sequentially deposited on the base 2 in the mentioned order. It should be noted that the L0 information layer 3 is configured similarly to the L1 information layer 5 except that the L0 information layer 3 has the reflecting film 11, as will be described hereinafter. Therefore, materials of the films (the dielectric films 12 and 14, and auxiliary recording films 13a and 13b) forming the L0 information layer 3 will be described hereinafter when description is given of the corresponding films (dielectric films 15 and 17, and auxiliary recording films 16a and 16b) forming the L1 information layer 5. For example, the reflecting film 11 is in the form of a thin film made of an Ag alloy and having a thickness of 100 nm. The dielectric films 12 and 14 are formed in a manner sandwiching the recording film 13 such that they physically and chemically protect the recording film 13, thereby preventing degradation of recorded information for a long time period. Further, the dielectric films 12 and 14 are formed by dielectric materials having light transmittance in the wavelength region of the laser beam L. The recording film 13 is formed by depositing the two thin films, i.e. the auxiliary recording films 13a and 13b.

The transparent intermediate layer 4 is a resin layer for separating the LO information layer 3 and the L1 information layer 5 from each other by a physically and optically sufficient distance. The transparent intermediate layer 4 is, for example, formed by the 2P method in a manner covering the L0 information layer 3, and has a surface (upper surface as viewed in FIG. 1) thereof formed with grooves and lands serving as guide tracks for recording and reproducing data on and from the L1 information layer 5. In this case, it is preferred that the transparent intermediate layer 4 has a thickness within a range of 5 μm to 50 μm, and more preferably within a range of 10 μm to 40 μm. Although the material for forming the transparent intermediate layer 4 is not particularly limited, it is preferable to use a transparent resin material, such as an ultraviolet-curing acrylic resin, since the material is required to have a sufficiently high light transmittance.

The L1 information layer 5 is positioned nearer than the “farthest information layer (L0 information layer 3)” in the present invention, as viewed from the direction of irradiation of the laser beam L onto the optical information-recording medium 1. In the optical information-recording medium 1, there is only one layer located on the near side, so that the L1 information layer 5 forms the N-th information layer (N=2, in this case), and the M-th information layer (M=N, in this case) in the present invention. The L1 information layer 5 is a write-once type information layer, and as shown in FIG. 3, formed by sequentially depositing a dielectric film 15, a recording film 16, and a dielectric film 17 on the transparent intermediate layer 4 in the mentioned order. In this case, the L1 information layer 5 is required to have the function of passing (transmitting) therethrough the laser beam L irradiated toward the L0 information layer 3 when data is recorded or reproduced on or from the L0 information layer 3. Therefore, to enhance the transmittance of the laser beam L, the L1 information layer 5 has no reflecting film. However, it is possible to provide a reflecting film in the L1 information layer 5. To configure the L1 information layer 5 as such, a reflecting film having a very small thickness is formed in the L1 information layer 5 on a side toward the transparent intermediate layer 4, to the extent that the reflecting film does not obstruct the recording or reproduction of data on or from the L0 information layer 3 (sufficient amount of the laser beam L can pass through the reflecting film).

The dielectric films 15 and 17 correspond to first and second dielectric films in the present invention, respectively, and is in the form of thin films disposed in a manner sandwiching the recording film 16. The dielectric films 15 and 17 physically and chemically protect the recording film 16, thereby preventing degradation of recorded information for a long time period. Further, the dielectric films 15 and 17 can be used for increasing the amount of change in optical characteristics of the L1 information layer 5 before and after recording of data on the recording film 16. In this case, to increase the amount of change, it is preferable to employ a dielectric material having a high index of refraction (n) in the wavelength region of the laser beam L. Further, when the laser beam L is irradiated, if an excessively large amount of energy is absorbed by the dielectric films 15 and 17, recording sensitivity of the recording film 16 is reduced, so that it is preferred to employ a dielectric material having a small extinction coefficient (k) in the wavelength region of the laser beam L to thereby prevent the reduction of the recording sensitivity.

More specifically, from the viewpoint of prevention of thermal deformation of the transparent intermediate layer 4, and the like, and enhancement of protecting characteristics of the dielectric films 15 and 17 for protecting the recording film 16, it is preferable to employ any of Al₂O₃, AlN, ZnO, ZnS, GeN, GeCrN, CeO₂, SiO, SiO₂, Si₃N₄, SiC, La₂O₃, Ta₂O₅, TiO₂, SiAlON (mixture of SiO₂, Al₂O₃, Si₃N₄, and AlN), and LaSiON (mixture of La₂O₃, SiO₂, and Si₃N₄), any of oxides, nitrides, sulfides, and carbides of aluminum (Al), silicon (Si), cerium (Ce), titanium (Ti), zinc (Zn), and tantalum (Ta), and mixtures thereof, as dielectric materials for forming the dielectric films 15 and 17. In this case, the dielectric films 15 and 17 can be formed by the same dielectric material, or alternatively by dielectric materials different from each other. Further, one or both of the dielectric films 15 and 17 can be configured to have a multilayer structures formed by a plurality of dielectric films.

In the optical information-recording medium 1 according to the present invention, the dielectric film 15 (“dielectric film formed on a far side as viewed from a direction of irradiation of the laser beam” in the present invention) is formed by using a material having a mixture of ZnS and SiO₂ (preferably, molar ratio of ZnS: SiO₂=80:20) as the main component, such that the dielectric film 15 has a thickness within a range of 100 nm to 130 nm (e.g. 110 nm). In this case, the mixture of ZnS and SiO₂ has a relatively small extinction coefficient (k) with respect to the laser beam L in the wavelength region ranging from 380 nm to 450 nm, and hence it is possible to prevent the recording sensitivity of the recording film 16 from being reduced. Further, the dielectric film 17 (“a dielectric film formed on a near side as viewed from the direction of irradiation of the laser beam” in the present invention) is formed by using a material having TiO₂ as the main component such that the dielectric film 17 has a thickness within a range of 15 nm to 40 nm (e.g. 30 nm). In this case, TiO₂ has a high index of refraction (n) and a relatively small extinction coefficient (k), with respect to the laser beam L in the wavelength region ranging from 380 nm to 450 nm, and hence it is possible to make conspicuous the amount of change in optical characteristics of the L1 information layer 5 before and after recording of data on the recording film 16, and at the same time prevent the recording sensitivity of the recording film 16 from being degraded.

The recording film 16 is a layer having a recording mark irreversibly formed thereon. When the laser beam L adjusted to a recording power is irradiated onto the recording film 16, portions of the recording film 16 irradiated with the laser beam L have their state (at least one of a physical state and a chemical state) changed, whereby recording marks are irreversibly formed on the recording film 16. As shown in FIG. 3, the recording film 16 is formed by depositing two thin films, i.e. an auxiliary recording film 16a corresponding to a first auxiliary recording film in the present invention, and an auxiliary recording film 16b corresponding to a second auxiliary recording film in the present invention 16b, on the dielectric film 15. In this case, an area (blank area) having no data recorded thereon is maintained in the state where the auxiliary recording films 16a and 16b are layered. Further, when the laser beam L adjusted to the recording power is irradiated onto the blank area of the recording film 16, elements constituting the auxiliary recording films 16a and 16b are partially or entirely mixed with each other to thereby form recording marks. Mixed portions of the auxiliary recording films 16a and 16b, formed with the recording marks, exhibit a reflectance of the laser beam L which is very different from a reflectance exhibited by the blank area (portion of the recording film 16 maintained in the state of the auxiliary recording films 16a and 16b being layered). Therefore, in the optical information-recording medium 1, by detecting the difference in reflectance of the laser beam L, it is possible to reproduce recorded data (determine whether or not the recording marks exist). It should be noted that on the optical information-recording medium 1, there are formed, for example, recording marks having a length of 2T to 8T by the (1,7)RLL modulation method.

In this case, it is preferred that the auxiliary recording films 16a and 16b are formed by respective materials which each contain a different main component selected from a group consisting of aluminum (Al), silicon (Si), germanium (Ge), stannum (Sn), zinc (Zn), copper (Cu), magnesium (Mg), titanium (Ti), and bismuth (Bi). That is, it is preferable that the auxiliary recording film 16a is formed of a material having one element selected from the above group as the main component, and the auxiliary recording film 16b is formed of a material having another element of the above group as the main component. Further, to suppress the noise level of a reproduction signal to a low level, it is preferred that one of the auxiliary recording films 16a and 16b is formed of a material containing Cu as the main component, and the other is formed of a material containing Si as the main component. Further, when one of the auxiliary recording films 16a and 16b is formed of a material containing Cu as the main component, it is preferred to use a material obtained by adding any one or ones of Al, Zn, Sn, Au, and Mg to Cu. In the optical information-recording medium 1 according to the embodiment of the present invention, the auxiliary recording film 16a having a thickness of 5 nm is formed of a material obtained by adding Al in an amount of 23 atomic % and Au in an amount of 13 atomic % to Cu, while the auxiliary recording film 16b having a thickness of 4 nm is formed of a-material containing Si as the main component. It should be noted that when one of the auxiliary recording films 16a and 16b is formed of a material containing Al as the main component, it is preferred to add any one or ones of Mg, Au, Ti, and Cu, to Al. Further, when one of the auxiliary recording films 16a and 16b is formed of a material having Zn as the main component, it is preferred to add any one or ones of Mg, Al, Ti, and Cu, to Zn. Furthermore, when one of the auxiliary recording films 16a and 16b is formed of a material having Ti as the main component, it is preferred to add Al to Ti. By thus adding various kinds of materials as required, it becomes possible to decrease the noise level of the reproduction signal and at the same time prevent recorded data from being lost in a short time period, which makes it possible to enhance the reliability of the optical information-recording medium 1.

The recording film 16 formed using such materials as described above not only has a high light transmittance with respect to the laser beam L in the wavelength region ranging from 380 nm to 450 nm but also has a very small difference between the light transmittance of the portion (blank area) maintained in the state of the auxiliary recording films 16a and 16b being layered, and that of the mixed portion of the auxiliary recording films 16a and 16b (area of the recording film 16 formed with recording marks). More specifically, when the laser beam L in the wavelength region between 380 nm to 450 nm is used, the difference in light transmittance between the layered portion and the mixed portion is not more than 3%. Particularly when one of the auxiliary recording films 16a and 16b is formed of a material having Cu as the main component, and the other is formed of a material containing Si as the main component, the difference in light transmittance with respect to the laser beam L having a wavelength λ of 405 nm becomes not more than 1%. This makes it possible to stably record and reproduce data on and from the L0 information layer 3, irrespective of whether or not recording marks exists on the L1 information layer 5.

To further increase the light transmittance of the recording film 16, it is preferable to minimize the thickness of the recording film 16, to the extent that a sufficient difference in change in an optical constant before and after recording of data on the recording film 16 can be ensured. In this case, when the recording film 16 is formed to have a thickness of less than 2 nm, the amount of change in the optical characteristics of the L1 information layer 5 before and after recording of data on the recording film 16 is so small that it is difficult to normally reproduce the recorded data, whereas when the recording film 16 is formed to have a thickness of more than 15 nm, the light transmittance of the whole L1 information layer 5 is lowered, and hence there is a fear that the recording characteristics and reproducing characteristics of data to be recorded and reproduced on and from the L0 information layer 3 are degraded. Further, when the thickness of the recording film 16 is formed to be larger than 15 nm, there is a fear that the recording sensitivity of the L1 information layer 5 and the surface flatness of the auxiliary recording film 16b are degraded to increase (worsen) the noise level of the reproduction signal. To overcome these inconveniences, it is preferred that the thickness of the recording film 16 is set to a value within a range of 2 to 15 nm. It should be noted that the above construction of the recording film 16 is described only by way of example, and the recording film can be formed e.g. by a three-layer structure in which the auxiliary recording film 16b is sandwiched by two auxiliary recording films 16a , or by a three-layer structure in which a mixed layer containing a material for forming the auxiliary recording film 16a and a material for forming the auxiliary recording film 16b is formed between the auxiliary recording film 16a and the auxiliary recording film 16b. Furthermore, the recording film can be formed by a single-layer structure comprised of Sn, Ti, or the like. In this case, when the recording film is formed by either of the three-layer structures, manufacturing costs thereof are slightly increased compared with the recording film 16 with the two-layer structure of the auxiliary recording films 16a and 16b, since an additional layer-forming step is required. When the recording film is formed by the single-layer structure, the difference in reflectance of the laser beam L before and after recording of data tends to be slightly reduced compared with the recording film 16 having the two-layer structure. Therefore, it is preferred to employ the two-layer structure of the auxiliary recording films 16a and 16b. It should be note that the aforementioned dielectric films 15 and 17, and the recording film 16 (auxiliary recording films 16a and 16b) can be formed by the vapor phase growth method (e.g. the vacuum deposition method and the sputtering method) using chemical species (layer-forming materials) containing constituent elements forming the above layers.

The light transmitting layer 6 is coated with a thin film of an acrylic-based or epoxy-based ultraviolet-curing resin by the spin coating method or the like, such that the thickness of the light transmitting layer 6 is within a range of 30 μm to 200 μm. The light transmitting layer 6 is required to have a sufficiently high light transmittance, since the light transmitting layer 6 is used as an optical path of the laser beam L when data is recorded or reproduced. At the same time, the light transmitting layer 6 is required to have a certain degree of strength so as to prevent the L1 information layer 5 from being scratched. It should be noted that the light transmitting layer 6 is not limited to a layer coated with a resin material by the spin coating method or the like. For example, the light transmitting layer 6 can also be formed by affixing a thin plate formed by a light-transmitting resin to the L1 information layer 5 by a suitable one of adhesives and binding materials.

Next, the relationship between the thicknesses of the dielectric films 15 and 17 of the L1 information layer 5, and the transmittance and reflectance of the laser beam L will be described with reference to figures.

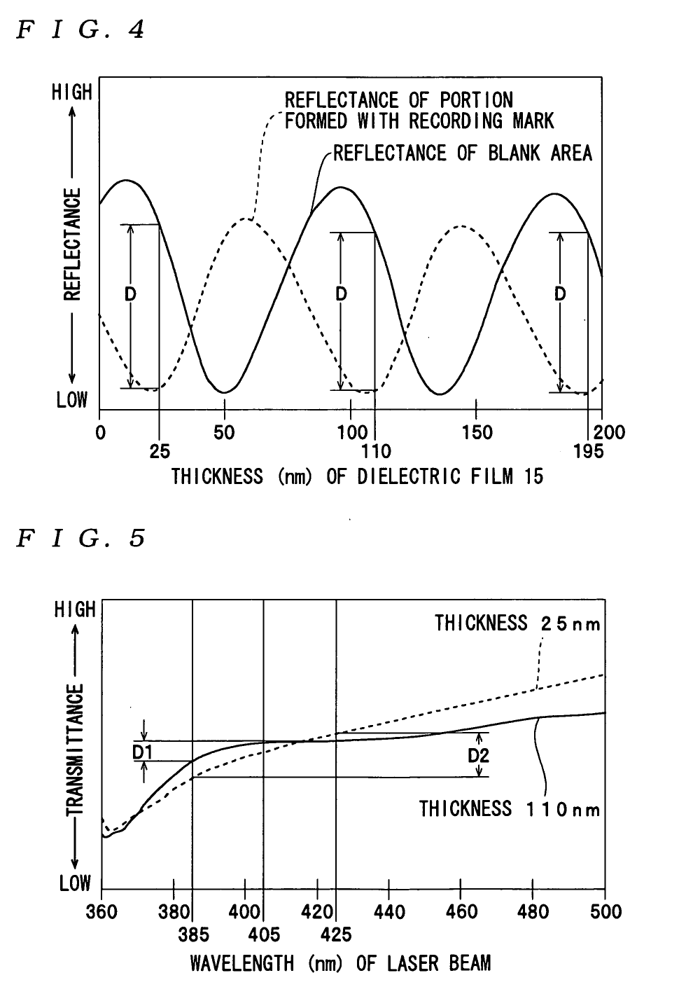

When data recorded on the L1 information layer 5 is reproduced, to read whether or not there is a recording mark formed on the recording film 16, a certain degree of difference is required to be caused between the reflectance of the laser beam L irradiated onto the layered portion (blank area) of the L1 information layer 5 where the auxiliary recording films 16a and 16b are layered, and the reflectance of the laser beam L irradiated onto the mixed portion (area formed with the recording mark) of the L1 information layer 5 where the auxiliary recording films 16a and 16b are mixed. In this case, as shown in FIG. 4, the reflectance of the laser beam L having a wavelength λ of 405 nm varies with the thickness of the dielectric film 15 or 17 (hereinafter, description will be given as to the dielectric film 15 alone as a representative of the two dielectric films). It should be note that in FIG. 4, the reflectance of the laser beam L irradiated onto the blank area is indicated by a solid line, and the reflectance of the laser beam L irradiated onto the area formed with the recording mark is indicated by a broken line.

In this case, when the dielectric film 15 is formed to have the same thickness (25 nm, in the illustrated example) as that of the dielectric film of the conventional optical information-recording medium, it is possible to generate a difference D in reflectance at such a level that recorded data can be normally reproduced. However, when the dielectric film 15 is formed to have a thickness thinner than or equal to the thickness of the dielectric film of the conventional optical information-recording medium, as describe above, the recording film 16 is liable to be corroded with water or the like in the atmosphere having intruded from the side of the base 2. On the other hand, in order to generate a difference D at the same level and as approximately equal to the difference D in the reflectance of the optical information-recording medium including a dielectric film 15 having a thickness of 25 nm, at the same time to make the reflectance of the laser beam L irradiated onto the mixed portion (area formed with the recording mark) smaller than the reflectance of the laser beam L irradiated onto the blank area, it is only required to form the dielectric film 15 such that it has a thickness of approximately 110 nm or approximately 195 nm. In this case, when the thickness of the dielectric film 15 is defined to be approximately 195 nm, there is a fear that the dielectric film 15 is cracked when the whole optical information-recording medium 1 is bent or when the optical information-recording medium 1 experiences a sharp change in temperature. Therefore, in the illustrated example, the dielectric film 15 is formed to have a thickness of approximately 110 nm, whereby the corrosion of the recording film 16 and the crack in the dielectric film 15 are both prevented from occurring. It should be noted that when the thickness of the dielectric film 15 is set to approximately 110 nm, there is a fear of occurrence of a crack if the thickness of the dielectric film 17 is defined to be larger than 40 nm. Therefore, by forming the dielectric film 17 such that it has a thickness of not more than 40 nm (e.g. 30 nm), occurrence of the crack in the dielectric film 17 is prevented.

Referring to FIG. 5, the transmittance of the L1 information layer 5 varies with the wavelength of the laser beam L (i.e. it is wavelength dependent). It should be noted that in FIG. 5, a transmittance of an L1 information layer 5 including a dielectric film 15 having a thickness of 110 nm, which is exhibited with respect to each wavelength of the laser beam L irradiated thereto, is indicated by a solid line, and a transmittance of an L1 information layer 5 including a dielectric film 15 having a thickness of 25 nm, which is exhibited with respect to each wavelength of the laser beam L irradiated thereto is indicated by a broken line. In this case, in the L1 information layer 5 including the dielectric film 15 having a thickness of 25 nm, the amount D2 of change in transmittance thereof, in a wavelength region within a range of approximately ±5% with respect to the wavelength (405 nm) of the laser beam L (wavelength region between 385 nm to 425 nm, in the illustrated example) is larger than the amount D1 of change in transmittance of the L1 information layer 5 including the dielectric film 15 having a thickness defined to be 110 nm. Therefore, the L1 information layer 5 including the dielectric film 15 having a thickness of 25 nm can have the transmittance thereof largely changed in response to a slight change in the wavelength of the laser beam L from 405 nm, which makes it difficult to record and reproduce record data on and from the L0 information layer 3. In contrast, in the case of the L1 information layer 5 including the dielectric film 15 having a thickness of 110 nm, the transmittance thereof is not largely changed by such a slight change in the wavelength of the laser beam L from 405 nm, so that it is possible to record and reproduce data on and from the L0 information layer 3 in a stable manner. In this case, when the dielectric film 15 is formed of a material having the mixture of ZnS and SiO₂ (molar ratio of ZnS: SiO₂=80:20) as the main component, the amount D1 of change in transmittance of the L1 information layer 5 can be suppressed to a sufficiently small value by defining the thickness of the dielectric film 15 to be within the range of 100 to 130 nm. In configuring the L1 information layer 5 as above, it is preferred that the dielectric film 17 is formed of a material having TiO₂ as the main component such that the dielectric film 17 has a thickness defined to be within a range of 15 to 40 nm. This makes it possible to suppress the amount of change in transmittance of the L1 information layer 5 in the wavelength region within the range of approximately ±5% with respect to the wavelength (405 nm) of the laser beam L, to a still smaller value.

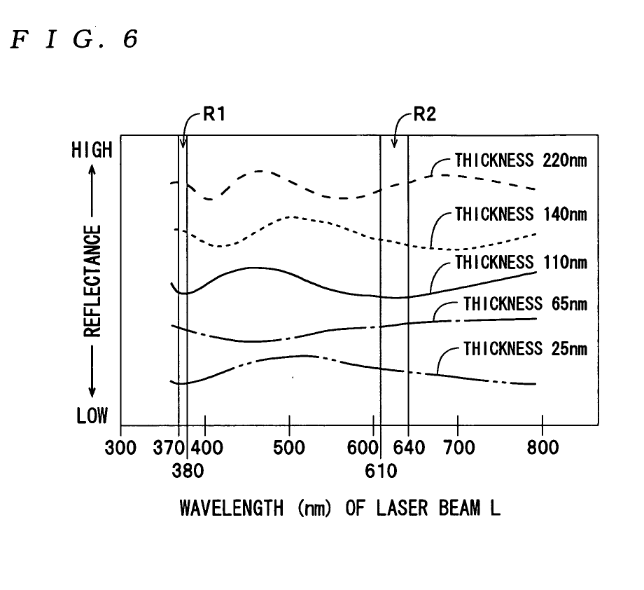

Furthermore, as shown in FIG. 6, the wavelength dependency of the reflectance of the L1 information layer 5 varies with the thickness of the dielectric film 15. Now, the term “reflectance of the L1 information layer 5” discussed in the following is intended to mean a light reflectance in an unrecorded area (blank area) of the recording film 16 of the L1 information layer 5. More specifically, in an L1 information layer 5 including a dielectric film 15 having a thickness defined to be 25 nm, as indicated by a two-dot chain line, the reflectance thereof assumes a minimum value at a wavelength of approximately 370 nm. In an L1 information layer 5 including a dielectric film 15 having a thickness defined to be 65 nm, as indicated by a one-dot chain line, the reflectance thereof assumes a minimum value at a wavelength of approximately 450 nm. In an L1 information layer 5 including a dielectric film 15 having a thickness defined to be 110 nm, as indicated by a solid line, the reflectance thereof assumes minimum values in both of a wavelength region R1 (first wavelength region in the present invention) ranging from 370 nm to 380 nm (the wavelength is 372 nm, in the illustrated example), and a wavelength region R2 (second wavelength region in the present invention) ranging from 610 nm to 640 nm (the wavelength is 630 nm, in the illustrated example). Further, in an L1 information layer 5 including a dielectric film 15 having a thickness defined to be 140 nm, as indicated by a broken line, the reflectance thereof assumes minimum values at respective wavelengths of approximately 410 nm and approximately 680 nm. Furthermore, in an L1 information layer 5 including a dielectric film 15 having a thickness defined to be 220 nm, as indicated by a rough broken line, the reflectance thereof assumes minimum values at respective wavelengths of approximately 400 nm and approximately 550 nm.

As described above, only the L1 information layer 5 including the dielectric film 15 having the thickness defined to be 110 nm has a characteristic that the reflectance thereof assumes the minimum value in both of the wavelength regions R1 and R2. Further, as to L1 information layers 5 including respective dielectric films 15 having thicknesses other than this thickness, it is confirmed that the L1 information layer 5 has a characteristic that the reflectance thereof does not assume a minimum value in at least one of the wavelength regions R1 and R2. In this case, if the L1 information layer 5 includes a dielectric film 15 having a thickness defined to be within a range of 100 nm to 130 nm, it is confirmed that the L1 information layer 5 has a characteristic that the reflectance thereof assumes minimum values in both of the wavelength region R1 ranging from 370 nm to 380 nm, and the wavelength region R2 ranging from 610 nm to 640 nm. Accordingly, by defining the thickness (110 nm, in the illustrated example) of the dielectric film 15 such that the reflectance assumes the minimum values in both of the wavelength regions R1 and R2, it becomes possible to record and reproduce data on and from the L0 information layer 3 in a stable manner, while preventing occurrence of the corrosion of the recording film 16 and the crack in the dielectric film 15. As to the dielectric film 17, it is confirmed that by defining the thickness of the dielectric film 17 within a range of 15 nm to 40 nm, the L1 information layer 5 including the dielectric film 17 has a characteristic that the reflectance thereof assumes minimum values in both of the wavelength region R1 ranging from 370 nm to 380 nm, and the wavelength region R2 ranging from 610 nm to 640 nm. Therefore, by defining the thickness (30 nm, in the illustrated example) of the dielectric film 17 such that the reflectance of the L1 information layer 5 assumes minimum values in both of the wavelength regions R1 and R2, it becomes possible to record and reproduce data on and from the L0 information layer 3 in a stable manner, while preventing occurrence of a crack in the dielectric film 17.

In this case, in the optical information-recording medium 1 having the L0 information layer 3, the transparent intermediate layer 4, the L1 information layer 5, and the light transmitting layer 6, sequentially deposited on the base 2, it is difficult to identify the thickness of the dielectric film 15 in the L1 information layer 5. On the other hand, by measuring the reflectance of the laser beam L which has been irradiated onto the L1 information layer 5 and reflected therefrom with respect to each wavelength, the thickness of the dielectric film 15 can be identified with ease even if the optical information-recording medium 1 has the layers 3 to 6 deposited on the base 2. More specifically, if the L1 information layer 5 has the characteristic that the reflectance thereof assumes minimum values in both of the wavelength regions R1 and R2, it is determined that the thickness of the dielectric film 15 is within the range of 100 nm to 130 nm, whereas if the L1 information layer 5 has the characteristic that the reflectance thereof does not assume a minimum value in at least one of the wavelength regions R1 and R2, it is determined that the thickness of the dielectric film 15 is outside the range of 100 nm to 130 nm. This makes it possible to easily and reliably inspect the thickness of the dielectric film 15 without causing any damage to the optical information-recording medium 1, e.g. on a manufacturing site where the optical information-recording medium 1 is manufactured. In this case, also as to the L1 information layer 5 including the dielectric film 17, if the L1 information layer 5 has the characteristic that the reflectance thereof assumes minimum values in both of the wavelength regions R1 and R2, it can be determined that the thickness of the dielectric film 17 is within the range of 15 nm to 40 nm, whereas if the L1 information layer 5 has the characteristic that the reflectance thereof does not assume a minimum value in at least one of the wavelength regions R1 and R2, it can be determined that the thickness of the dielectric film 17 is outside the range of 15 nm to 40 nm. This makes it possible to easily and reliably inspect the thickness of the dielectric film 17 without causing any damage to the optical information-recording medium 1, e.g. on a manufacturing site where the optical information-recording medium 1 is manufactured.

Next, description will be given of the method of using the optical information-recording medium 1.

First, a lens having a numerical aperture (NA) e.g. of 0.7 or more, preferably approximately 0.85 is used as an objective lens for converging a laser beam L, and a laser beam L having a wavelength λ of approximately 405 nm is used. In this case, when data is recorded on the L1 information layer (L1 information layer including the dielectric film 15 having a thickness of 110 nm) 5 of the optical information-recording medium 1, the laser beam L adjusted to the recording power is irradiated onto the optical information-recording medium 1 from the side of the light transmitting layer 6. At this time, the recording film 16 onto which the laser beam L is irradiated is heated, whereby elements composing the auxiliary recording film 16a and elements composing the auxiliary recording film 16b are mixed with each other. The portion where the auxiliary recording films 16a and 16b are mixed with each other by the irradiation of the laser beam L as described above, forms a recording mark whose reflectance is largely different from the reflectance of the blank area. Therefore, by detecting the difference between the reflectances, it becomes possible to perform reproduction of the data.

In this case, in the optical information-recording medium 1 according to the present invention, since the film thickness (thickness) of the dielectric film 15 in the L1 information layer 5 is defined to be 110 nm, and the film thickness (thickness) of the dielectric film 17 is defined to be 30 nm, the wavelength dependency of the reflectance of the L1 information layer 5 is very small. Therefore, even if the wavelength of the laser beam L is changed to a certain degree e.g. due to differences between individual recording and reproducing apparatuses, and changes in temperature during recording or reproduction of data, the amount of change in the amount of the laser beam L reaching the L0 information layer 3 below the L0 information layer 3, and the amount of change in the amount of the laser beam L reflected from the L0 information layer 3 are very small.

As described hereinabove, according to the optical information-recording medium 1, the L1 information layer 5 is formed by defining the thicknesses of the dielectric films 15 and 17 such that the reflectance of a laser beam L whose wavelength is in the wavelength region R1 ranging from 370 nm to 380 nm, and the reflectance of a laser beam L whose wavelength is in the wavelength region R2 ranging from 610 nm to 640 nm both assume minimum values relative to the reflectances of the other laser beams L whose wavelengths are outside the wavelength regions R1 and R2. This makes it possible to record and reproduce data on and from the L0 information layer 3, in a stable manner while preventing occurrence of corrosion of the recording film 16 and cracks in the dielectric films 15 and 17, and reduction of recording sensitivity of the recording film 16.

Further, according to the optical information-recording medium 1, the dielectric film 15 is formed of a material including a mixture of ZnS and SiO₂ as the main component such that the thickness thereof is within a range of 100 nm to 130 nm (110 nm, in the illustrated example), whereby the reflectances of the laser beams L whose wavelengths are within the wavelength regions R1 and R2 both assume minimum values relative to the reflectances of the other laser beams L whose wavelengths are outside the wavelength regions R1 and R2. In this case, the elements ZnS and SiO₂ have a relatively small extinction coefficient (k) with respect to the blue-violet laser beam L, and hence it is possible to reliably prevent the recording sensitivity of the recording film 16 from being reduced. Further, differently from a case where the thickness of the dielectric film 15 is defined to be smaller than 100 nm, it is possible to reliably prevent the recording film 16 from being corroded with water or the like in the atmosphere. Furthermore, differently from a case where the thickness of the dielectric film 15 is defined to be larger than 130 nm, it is possible to positively prevent occurrence of a crack in the dielectric film 15.

Furthermore, according to the optical information-recording medium 1, the dielectric film 17 disposed on the near side of the medium 1 as viewed from the direction of irradiation of the laser beam L is formed of a material having TiO₂ as the main component, whereby the reflectances [reflectances of the unrecorded area (blank area) of the recording film 16 in the L1 information layer 5] of the laser beams L whose wavelengths are within the wavelength regions R1 and R2 both assume minimum values relative to the reflectances of the other laser beams L whose wavelengths are outside the wavelength regions R1 and R2. In this case, TiO₂ has a high index of refraction (n) and a relatively small extinction coefficient (k), with respect to the blue-violet laser beam L, and hence it is possible to make conspicuous the amount of change in optical characteristics of the L1 information layer 5 before and after recording of data on the recording film 16, and prevent the recording sensitivity of the recording film 16 from being degraded.

Further, according to the optical information-recording medium 1, the recording film 16 is formed by depositing the auxiliary recording film 16a formed of a material containing Cu as the main component, and the auxiliary recording film 16b formed of a material containing Si as the main component, whereby the difference in reflectance between before and after irradiation of the laser beam L adjusted to the recording power, having a wavelength ranging from 380 nm to 450 nm is large, and at the same time, the difference in transmittance between before and after the irradiation is small. This makes it possible to reliably and easily form readable recording marks without obstructing the recording and reproduction of data on and from the L0 information layer 3.

It should be noted that the present invention is by no means limited to the aforementioned embodiment. For example, although in the above-described embodiment, the description has been given of the optical information-recording medium 1 including two information layers, i.e. the L0 information layer 3 and the L1 information layer 5, this is not limitative, but an optical information-recording medium having three or more information layers is included in the present invention. In this case, by applying the present invention to respective dielectric films contained in an information layer disposed on the near side of the medium 1 as viewed from the direction of irradiation of the laser beam L, it is possible to record and reproduce data in and from a lower information layer in a stable manner. Further, although the description has been given of the optical information-recording medium 1 configured to be irradiated with the laser beam L from the side of the light transmitting layer 6, this is not limitative, but the optical information-recording medium 1 may be configured to be irradiated with the laser beam L from the side of the base 2. In this case, the dielectric film 14 in the L0 information layer 3 (M-th information layer in the present invention) is configured similarly to the dielectric film 15 in the L1 information layer 5, and the dielectric film 12 is configured similarly to the dielectric film 17.

1. An optical information-recording medium including a plurality of information layers from a first information layer to an N-th information layer (N is a natural number not smaller than 2) sequentially formed on a base in the mentioned order, for recording and reproducing data by irradiating a laser beam onto said information layers,
wherein an M-th information layer (M is a natural number not larger than N), which is one of said N information layers, other than an information layer as a farthest information layer as viewed from a direction of irradiation of the laser beam onto the optical information-recording medium, is formed by depositing a first dielectric film and a second dielectric film, and a recording film formed between said first and second dielectric films such that the data can be recorded thereon, one upon another, and
wherein said first and second dielectric films have thicknesses thereof defined such that when the laser beam is irradiated onto said M-th information layer, a reflectance of said M-th information layer exhibited with respect to a laser beam in a first wavelength region ranging from 370 nm to 380 nm, and a reflectance of said M-th information layer exhibited with respect to a laser beam in a second wavelength region ranging from 610 nm to 640 nm both assume minimum values relative to reflectances of other laser beams whose wavelengths are outside the first and second wavelength regions.

2. An optical information-recording medium as claimed in claim 1, wherein at least one of said first and second dielectric films is formed of a material containing a mixture of ZnS and SiO₂ as a main component such that a thickness thereof is within a range of 100 nm to 130 nm.

3. An optical information-recording medium as claimed in claim 2, wherein said dielectric film of said M-th information layer formed on a far side as viewed from the direction of irradiation of the laser beam is formed of a material containing a mixture of ZnS and SiO₂ as a main component, and
wherein said dielectric film of said M-th information layer formed on a near side as viewed from the direction of irradiation of the laser beam is formed of a material containing TiO₂ as a main component.

4. An optical information-recording medium as claimed in claim 1, wherein said recording film is formed by depositing a first auxiliary recording film, and a second auxiliary recording film formed of a material different from a material forming said first auxiliary recording film.

5. An optical information-recording medium as claimed in claim 4, wherein said first and second auxiliary recording films are formed by materials containing respective ones different from each other and selected from the group consisting of Al, Si, Ge, Sn, Zn, Cu, Mg, Ti, and Bi.

6. An optical information-recording medium as claimed in claim 5, wherein one of said first and second auxiliary recording films is formed of a material containing Cu as the main component, and the other of said first and second auxiliary recording films is formed of a material containing Si as the main component.
